(19) United States
(12) Patent Application Publication
(10) Pub. No.: US 2003/0144850 A1
(43) Pub. Date: Jul. 31, 2003

(54) Method and apparatus for internet transaction processing

(76) Inventors: Robert Benjamin Franks, Walker Edge (GB); Martin Neilson, Almondbury (GB)

Correspondence Address: HARNESS, DICKEY & PIERCE, P.L.C., P.O. BOX 828, BLOOMFIELD HILLS, MI, 48303, US

(21) Appl. No.: 10/030,821

(22) PCT Filed: May 9, 2001
(86) PCT No.: PCT/GB01/02018

(30) Foreign Application Priority Data
May 11, 2000 (GB) 0011245.8

(51) Int. Cl. G06F 17/60

(52) U.S. Cl. 705/1

(57) ABSTRACT

Specific implementations of the invention encompass a tool usable by a customer for quickly and efficiently applying to register a trade mark application at one of a plurality of governmental or intergovernmental bodies, with minimum delay and optimized response time. The tool may also provide the facility to conduct a suitable trade mark search prior to the filing of a trade mark application.

### Field of the Invention

The present invention relates to the field of electronic commerce systems and, particularly to an electronic commerce system capable of handling transactions concerning the filing and registration of trade mark applications, and the searching of trade mark databases.

### Background to the Invention

Historically, trade mark rights have been allocated according to local or national laws by a process of registering trade mark applications at governmental or intergovernmental bodies. Historically, transactions have been via a paper-based application process involving the filling in of paper application forms which are then sent by surface mail or by facsimile to a governmental office by a trade mark agent or trade mark attorney. However, the current state of the art methods for filing and prosecution of trade mark applications have several drawbacks.

A first problem with the conventional system of trade mark application, is the time delay in filing an application. In many countries, trade mark rights are accorded on a ‘first to file’ basis. The inherent delays in the paper-based system work to the disadvantage of trade mark users and trade mark owners, since it introduces an arbitrary delay and risk of obtaining a filing date which does not truly reflect the trade mark user's or trade mark owner's first date of decision to use or invest in use of a trade mark.

Typically a person wishing to register a trade mark may approach a firm of trade mark agents or a firm of lawyers, and engage in a meeting in which details of the mark and its goods and usage will be recorded and instructions taken. The conventional registered trade mark application process involves a client either being physically present at a lawyers office or, alternatively, phoning the lawyer from a telephone. During an instruction meeting for instructing a trade mark application, a client may be able to confirm the precise details of the application with a trade mark lawyer. However, where a client gives instructions by telephone to a trade mark lawyer, the trade mark lawyer may not, and in many cases does not, give a precise confirmation of the exact details of the trade mark application to be made within that telephone conversation, but confirms those details by means of a separate communication, e.g. a letter or fax, which incurs further delay, with a period ranging from hours to months, before the client can confirm the exact details of the trade mark to be registered. The trade mark agency/law firm then applies to file the application at the relevant government body. Human delays are present in this system. For example, the trade mark lawyer may become sick, go on holiday, have a day off, put other client's work in front of the trade mark application or delay the application for various other reasons. The trade mark lawyer will file the application directly at a government trade mark office, or, in the case of a foreign trade mark, may send the application to a foreign associate by means of fax, letter or email instruction. In the case of filing at a government office, the government office may take a few days or perhaps a few weeks to issue an official filing receipt. This is then sent back to the trade marks lawyer who then reports it to his client, the whole process taking a matter of days to weeks. In the case of filing a foreign trade mark application, the trade marks lawyer sends the application to a foreign associate, who then incurs an additional delay in turning around the application in the foreign associates office. The delay in the foreign associates office can be of the order of days to months, depending upon the efficiency of the foreign associate. This works to the detriment of the applicant to register the trade mark, since days or months are lost between the meeting or instruction and an application being filed at the government office to register the trade mark. This exposes the person wishing to register a trade mark to the risk of third parties applying to register an identical or similar mark first, thereby disrupting the person's usage of the trade mark which can have severe financial implications for their business.

Secondly, conventionally the trade mark application process is a relatively costly procedure. Meetings with qualified trade mark agents, either by telephone or in person, incur professional fees at relatively high hourly rates, and processing of trade mark applications by attorneys incur either fixed charges, derived originally from hourly rates, or actual professional time expended by trade mark lawyers being spent at their professional hourly rates. There is considerable perception amongst clients that trade mark applications should be handled by general solicitors, attorneys and lawyers, and in many territories it is not legal requirement that a trade mark application be handled by a qualified trade marks lawyer. In many territories, trade mark applications are handled by general lawyers who have little or no experience or qualifications in the field of trade mark law. These lawyers tend to have hourly rates comparable or exceeding those of qualified and experienced trade mark lawyers or agents, and yet are unable to offer the efficiencies of experience and volume which qualified experienced specialist trade mark lawyers can pass on to their clients.

Thirdly, whilst specialist trade mark law firms are able to set up dedicated paper-based and word processing systems for the efficient preparation of paperwork for filing trade mark application documents, and delegate much of this work to less qualified, but skilled paralegal staff at relatively lower hourly rates, much of the basic work of preparing a trade mark application involves data entry, which is a relatively unskilled task, and which could be performed by unskilled persons.

Fourthly, whilst human trade mark agents in some (but not all countries) must learn trade mark law and pass examinations to give them a basic minimum level of competence, in many territories, trade mark applications are handled by individuals who have varying degrees of knowledge and in some cases very little legal knowledge. Contrary to this practical position, trade mark law varies from country to country, and it is practically impossible for a single human being to keep up-to-date with all trade mark laws of all countries in the world. Even keeping up-to date with laws of a single territory is a time intensive occupation, and even for qualified and experienced specialist trade mark agents, there are variable levels of knowledge from individual-to-individual. A customer faced with a selection of law firms will encounter an array of different human individuals having different knowledge and skill levels in the area of trade mark law and procedures. As a practical matter, quality of service can be variable even within individual firms, due to the different individuals constituting that firm, and depending upon which individual a customer interacts with. Even in a large and well-established specialist trade mark practice having many qualified and experienced trade mark agents, there will be large gaps in knowledge on the specifics of trade mark procedure in individual countries.

Additionally, it is established practice to conduct a trade mark search prior to filing a trade mark application. The search may highlight existing registered trade marks which are identical or very similar to the new proposed mark. The search results are used to assess the likelihood of obtaining registration. They also serve to indicate possible objections from proprietors of identical or similar marks thus helping to eliminate any future risk of infringement. Currently, a person wishing to conduct a trade mark search has to employ the services of a trade mark agent, who may subcontract the work to a third party incurring delay in view of the necessity for telephone, face-to-face or written communication.

The applicant has realized that the inherent delays and costs incurred in filing a trade mark application arise, in part, from the inefficiencies of face-to-face or telephone meetings with trade mark lawyers or general lawyers, and the historically necessary involvement of such lawyers in the trade mark application process, and also in the inefficiencies of handling a trade mark application once received. The applicant has also realized that by application of new and inventive communications technology and interfaces as described herein, a direct advantage can be achieved for an applicant in terms of turnaround times for filing a trade mark application, and the cost of filing a trade mark application, whilst still maintaining the input of a qualified and experienced specialist trade marks agent in handling such applications.

The applicant has also realized that the utilization of communication technology and interfaces described herein, provides a considerable speed advantage with regard to obtaining search results of a trade mark database.

Several prior art websites exist where a customer can instruct a firm to file a registered trade mark application. However, due to the complexities of offering trade mark applications in different countries, the prior art websites, in general, offer single country filing only. Further, the websites only provide a means of removing the trade mark lawyer-customer inefficiencies, but do nothing to speed up the processing of registered trade mark applications are instructed. An instruction received over a prior art website to file a registered trade mark application will be processed by a firm using prior art paper-based filing methods.

### Summary of the Invention

Specific implementations of the invention encompass a tool usable by a customer for quickly and efficiently applying to register a trade mark application at one of a plurality of governmental or intergovernmental bodies, with minimum delay and optimized response time. The tool may also provide the facility to conduct a suitable trade mark search prior to the filing of a trade mark application.

Specific implementations of the invention seek to replace conventional lines of communication used in the trade mark application and trade mark search process with lines of electronic communication so that apart from data entry by a customer at a customer terminal, all further processing of a trade mark application is electronic and automated as far as possible. The embodiments also seek to replace direct human-to-human interaction in the form of a meeting or telephone call for the purpose of taking details of a trade mark application or trade mark search, with a human-to-machine interaction via a user interface. The user interface may be present at a wide range of locations throughout the world, in the form of a web browser.

Specific implementations of the invention seeks to give an immediate and accurate feedback of exact trade mark application and trade mark search details to a client, via the user interface, so the client can be sure of the exact scope of legal rights which are to be applied for, immediately within a user session at the user interface. Time delays of hours to months in confirming details of a trade mark application to be filed, including any search results, may be avoided by use of the specific embodiments described herein.

Further, specific implementations according to the present invention seek to remove the deficiencies in knowledge of human trade mark agents and lawyers, by the use of database information and expert system technology, for the purpose of providing improved chance of success in a registered trade mark application process, and ensuring that the registered trade mark application complies with legal requirements.

Specific implementations according to the present invention seek to apply collective human knowledge and experience to a machine system including legal databases and expert systems, for the purpose of improving reliability and quality of service offered to a customer for the filing and registration of trade marks.

Other aspects of the invention are as described in the claims herein, which also form part of the description of the best mode described herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically an overview of a document system for serving a plurality of customers for the purpose of filing registered trade mark applications;

FIG. 2 illustrates schematically individual machine components comprising the service system of FIG. I herein;

FIG. 3 illustrates schematically individual components of a client platform according to a specific implementation of the present invention;

FIG. 4 illustrates schematically logical components of the client platform of FIG. 3;

FIG. 5 illustrates schematically a data message received by the client platform from a server platform;

FIG. 6 illustrates schematically data flows controlled by the client platform of FIG. 3;

FIG. 7 illustrates schematically a mode of operation of the client platform of FIG. 3 for processing a registered trade mark application received from a customer terminal via the server platform;

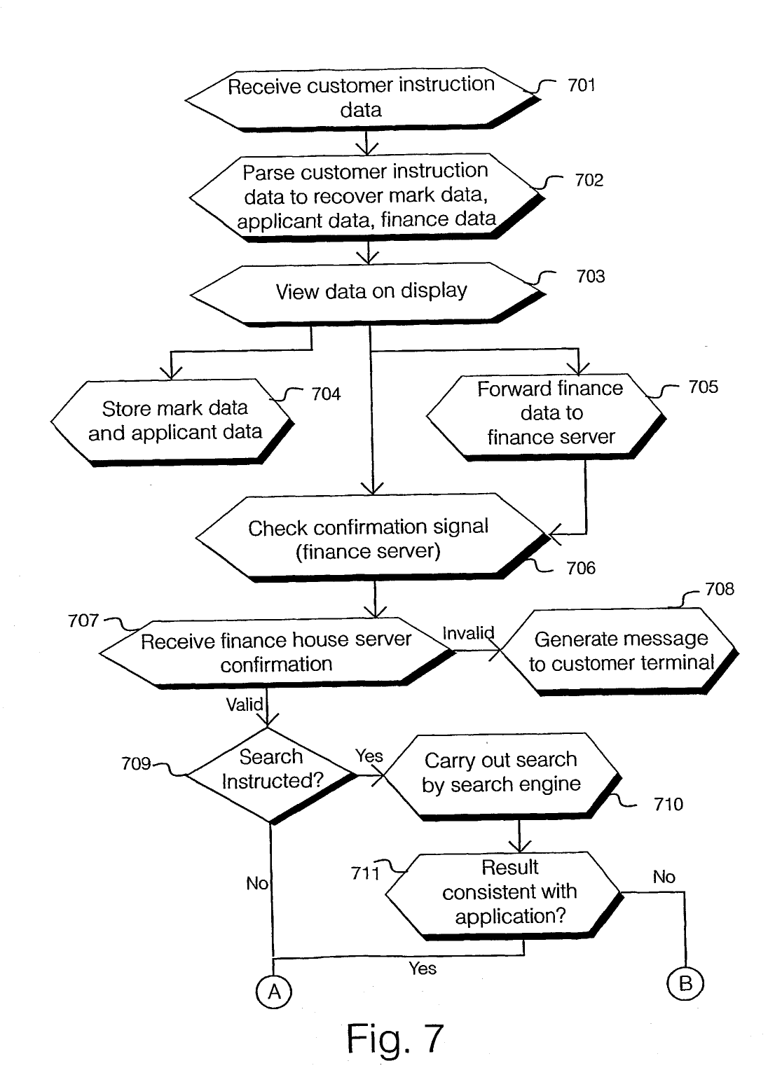

FIG. 8 illustrates schematically components of a server platform according to a specific implementation of the present invention;

FIG. 9 illustrates schematically a logical architecture of the server platform of FIG. 8 herein;

FIG. 10 illustrates schematically a view of a homepage visual display at the server platform, viewable by a customer terminal using a web browser;

FIG. 11 illustrates schematically an order form page display at the server platform, viewable by a web browser at a customer terminal;

FIG. 12 illustrates schematically a view of a law page display at the server platform, viewable by a web browser at a customer terminal;

FIG. 13 illustrates schematically a view of a registration process display page at the server platform, viewable by a web browser at a customer terminal;

FIG. 14 illustrates schematically a mode of operation of the server platform of FIG. 8 for processing a registered trade mark application in response to a request made at a customer terminal;

FIG. 15 illustrates schematically a view of trade mark data entry section of the order form display at the customer terminal;

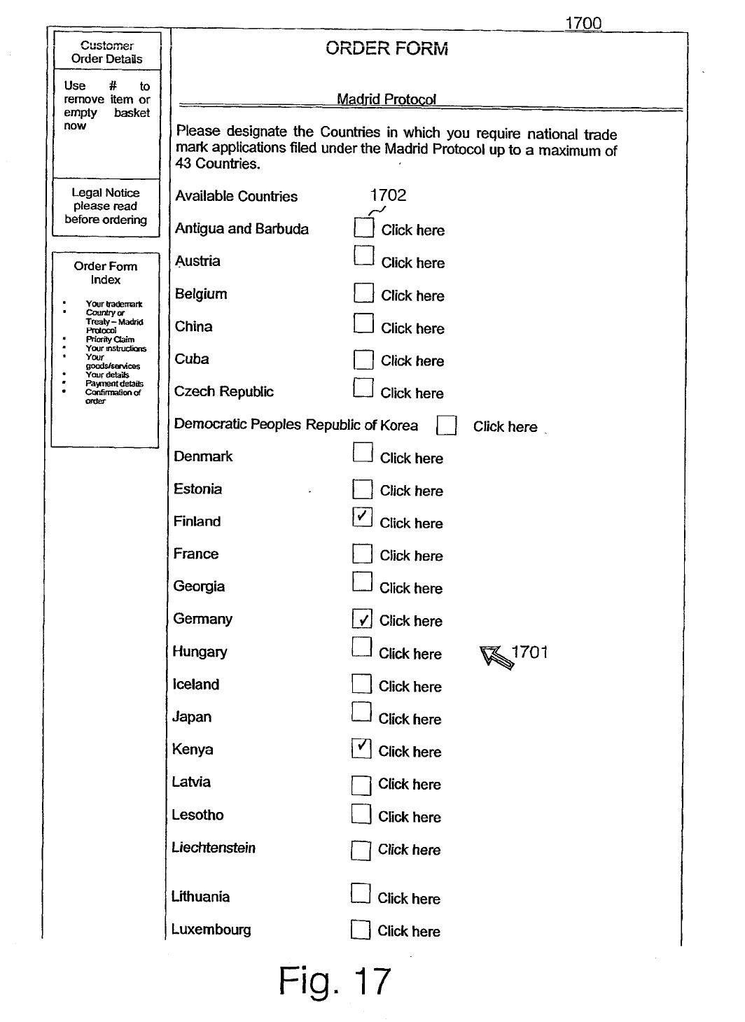

FIG. 16 illustrates schematically a view of a country/treaty data entry section of the order form display at a customer terminal;

FIG. 17 illustrates schematically a view of an individual territory selection section of the order form display presented at the customer terminal, for a regional trade mark application;

FIG. 18 illustrates schematically a view of an instruction section of the order form display as presented at the customer terminal;

FIG. 19 illustrates schematically a view of a goods/services data entry section comprising the order form display presented at the customer terminal;

FIG. 20 illustrates schematically a view of a priority claim data entry section of the order form page, as presented at the customer terminal;

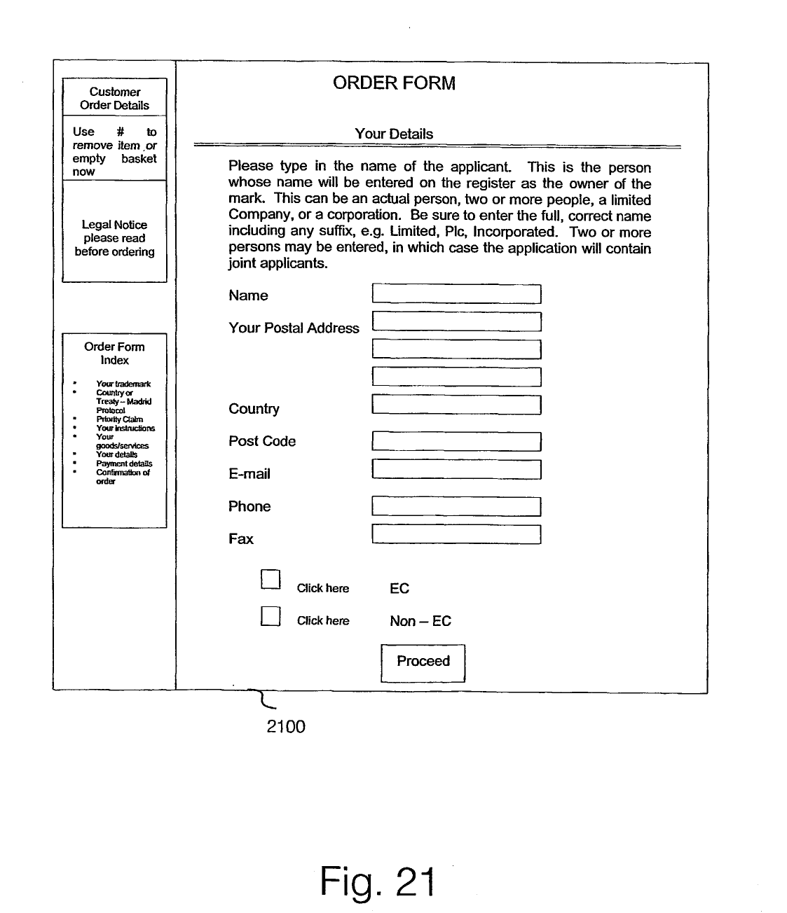

FIG. 21 illustrates schematically a customer details data entry section of the order form page display presented at the customer terminal;

FIG. 22 illustrates schematically a view of payment details entry section of the order form page display presented at the customer terminal;

FIG. 23 illustrates schematically a confirmation of order interactive information and data entry section of the order form page display as presented at the customer terminal; and

FIG. 24 illustrates schematically an order completion section of the order form display page viewable at the customer terminal.

### Detailed Description of the Best Mode for Carrying Out the Invention

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification, the terms ‘platform’ and ‘personal platform’ refer to any device having data processing capability, capability to communicate with other computer entities, and a user interface having a visual display, and includes computers which comply with standard PC format, Macintosh®, Psion® palmtop devices, laptop computers and mobile phones operating under the known wireless access protocol (WAP).

The term ‘computer entity’ includes any device having data processing capability, a data processor and associated memory, and includes computer platforms and platforms.

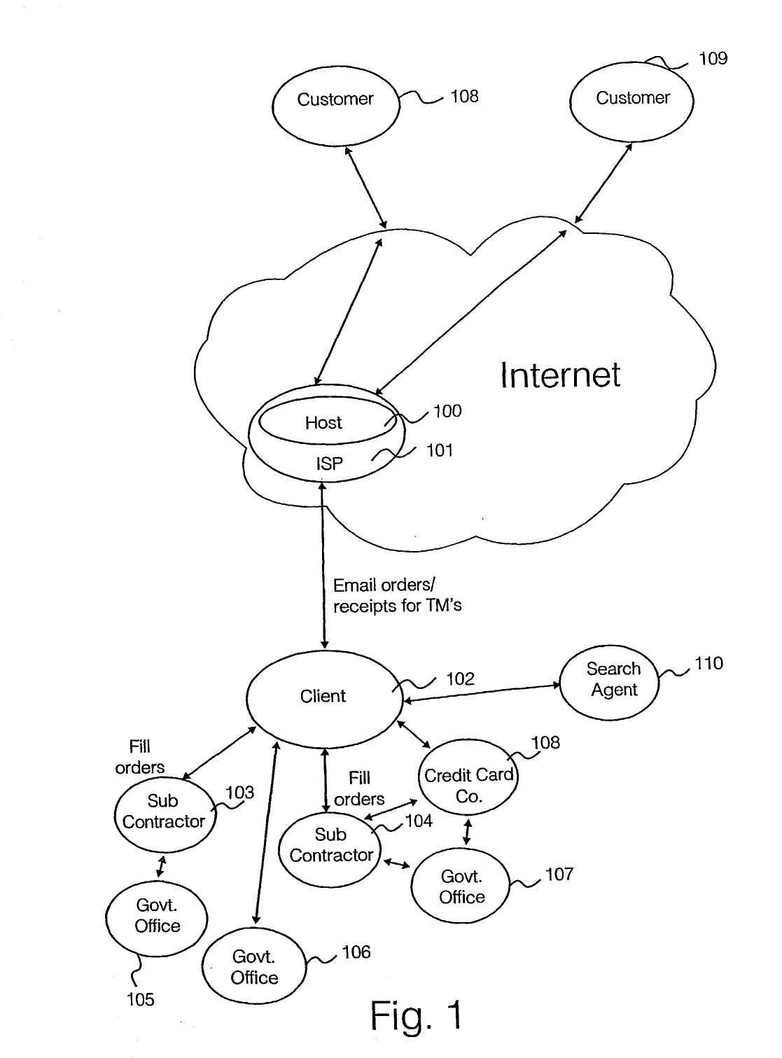

Referring to FIG. 1 herein, there is illustrated schematically a system of co-operating computer entities for providing automated filing of registered trade mark applications at a plurality of governmental or intergovernmental trade mark offices from a plurality of remote locations. The system comprises a host server computer entity 100, for example residing at an internet service provider body 101; a client terminal computer entity 102 in communication with the host server 100 via a dedicated line, for example an ISDN line, or via a virtual private network (VPN), or via the internet; a plurality of sub-contractor terminal computer activities 103, 104, communicating with the client terminal 102 and/or the host server 100 via the internet, via one or more VPNs or via one or more ISDN lines; the client terminal 102 and each sub-contractor terminal 103, 104 communicating via the internet, via one or more VPNs, or via one or more ISDN lines with a plurality of governmental or intergovernmental terminals 105-107; one or more finance company server computer entities 108 communicating with one or more client terminals 102, one or more subcontractor terminals 104 and/or one or more government office server computer entities 107 via the internet, a VPN or one or more ISDN lines; and a plurality of customer terminal corn entities 108, 109, each capable of communicating with the host server 100 via the internet, a VPN, or one or more ISDN lines: and a search agent 110 which may also be accessed via the internet, a VPN or similar.

It will be understood in the general sense that each of a plurality of logical entities of a customer terminal, host server, internet service provider, client terminal, sub-contractor terminal, government or intergovernmental office server or finance company server may be interconnected with each other through any suitable communication medium, including the internet, a virtual private network, one or more land lines, for example ISDN lines, or through wireless links.

In overview, operation of the system is as follows. A plurality of individual customers for trade mark registration have customer terminals 108, 109. In the best mode, customer terminals are conventional computer platforms or the like, having a web browser and having access to the internet. Customers find the host server 100 using a direct connection or via a known search engine, e.g. Yahoo®, Alta Vista®, Lycos®, Web Top® or the like. The host server 100 presents an interactive web site display to each customer terminal 108, 109 simultaneously and in parallel on demand which is accessed by means of a web browser located at each customer terminal. Through the web site customers can make data entries at the customer terminals of information required for filing a registered trade mark application as described hereafter. The information is collected as digital customer instruction data by the host server, which upon receipt of a ‘proceed’ signal from a customer terminal sends a confirmation message back to the customer terminal that a trade mark application and/or a trade mark search has been instructed to be applied to registered.

The host server 100 forwards details of the customer instruction to a client terminal 102 which may reside at a remote location from the host server. The client terminal 102 processes a customer instruction and forwards a trade mark application instruction data to one or a plurality of sub-contractor terminals 103 and/or one of a plurality of government office servers 105-107 for implementing the filing of a trade mark application, and sends payment data to a finance server 108 for collection of payment.

In the case of trade mark application instruction data sent by the client terminal to a government office server, the government office server may return official filing confirmation data back to the client terminal. The client terminal may then relay the official filing confirmation data via the host server 100 to the customer at the customer terminal 108, 109 or to any other customer terminal specified by the customer.

The client terminal 102 may also send trade mark application instruction data to one of the sub-contractor terminals 103 which may then forward it to a government office server 105-107. In this case, a government office server may return official filing confirmation data via a said sub-contractor terminal 103 to the client terminal 102, which relays the official filing confirmation data via the host server 100 and back to a customer terminal 108, 109.

In a best mode implementation, data is transferred and processed electronically at the customer terminal, the host server 100, the client terminal 102, each sub-contractor terminal 104, and each government office server 105-107, as well as at the finance company server 108. In the best mode implementation, when filing a registered trade mark application data may be passed automatically between individual computer terminal and server entities in the system, without the need for human user interaction.

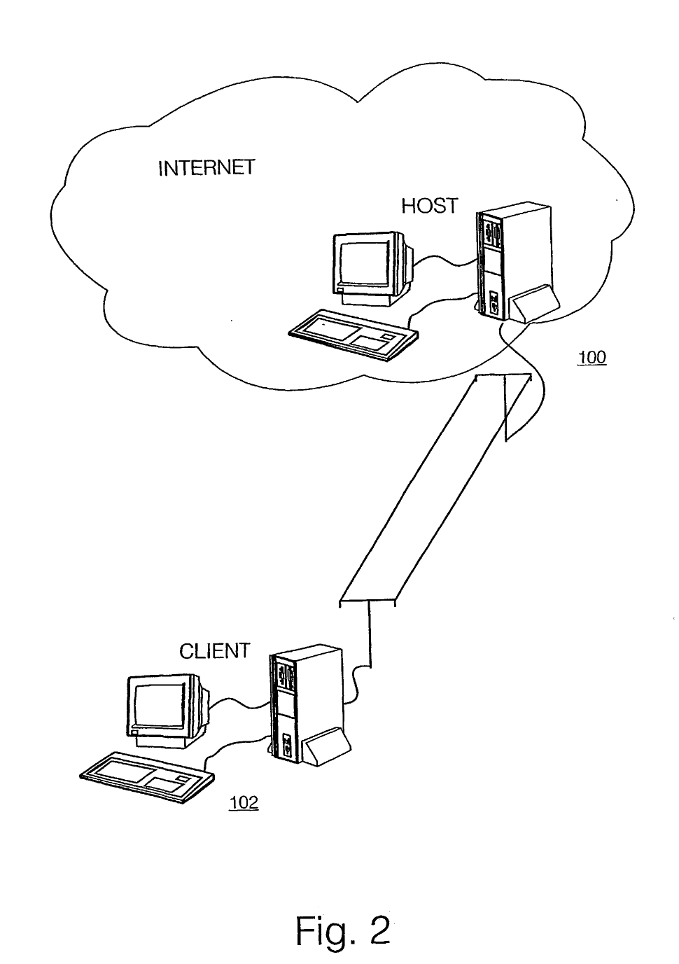

Referring to FIG. 2 herein, there is illustrated schematically individual hardware components comprising client terminal 102 and host server 100, connected by an internet communications link being one of the alternatives for communication between client terminal 102 and host server 100.

Client terminal 102 may comprise a conventional personal computer having a user interface, a keyboard, a modem and internet communications capability. The client terminal 102 comprises a user interface having a visual display unit, keyboard and pointing device to enable monitoring of trade mark applications by an operator, who is preferably a qualified trade mark attorney or qualified trade mark agent.

Similarly, the host server 100 may comprise a conventional computer, having sufficient data processing capability to host a plurality of website displays simultaneously, a modem for connecting the server to the internet for communication with the client terminal 102 and a plurality of said customer terminals, the host server having a user interface for monitoring by an operator comprising a visual display unit, keyboard and pointing device.

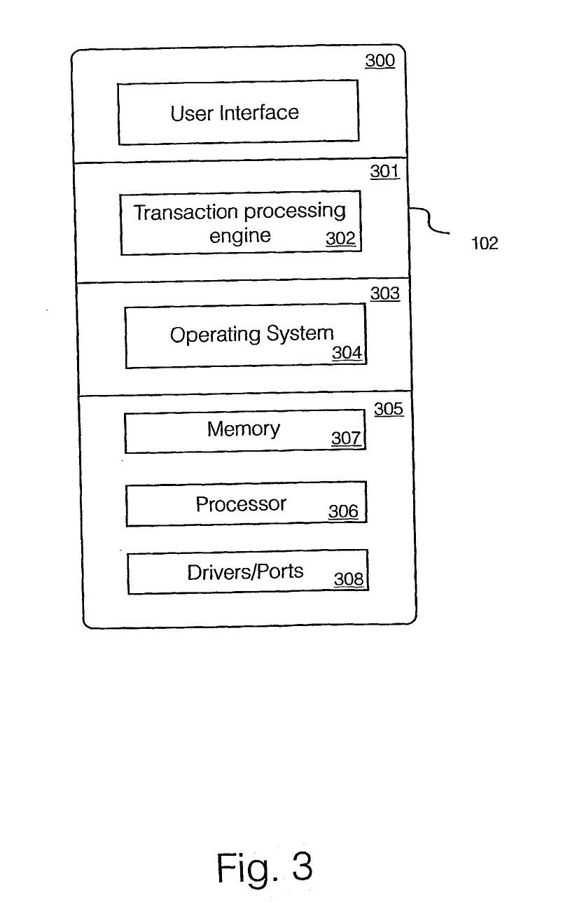

Referring to FIG. 3 herein, there is illustrated schematically components of the client terminal 102. The client terminal 102 comprises an interface layer 300 in which is provided a user interface, the user interface comprising a visual display monitor, a keyboard for data entry and a pointing device, the user interface capable of generating one or more displays for monitoring of trade mark applications being processed by the client terminal 102; a transaction layer 301 comprising a transaction processing engine 302 which operates to send and receive data to and from the host server 100 concerning the filing of trade mark applications; send data to one of more said sub-contractor terminals, send and receive data from one or more said governmental and/or intergovernmental servers 105-107, and communicate with one of more said finance servers 108; an operating system 304, for example the known Windows® 2000 or LINUX®) operating systems; and a hardware/firmware layer 305 comprising a one or more processors 306, memory 307 including RAM, ROM and hard disk memory; and a plurality of drivers and ports 308 including CD ROM writers, printer drivers, USB ports, and one or more modems.

Transaction processing engine 302 uses the underlying operating system and firmware/hardware 305 and user interface 300 to process and manage transactions concerning registration of trade marks, with facilities for interaction and monitoring by a human user.

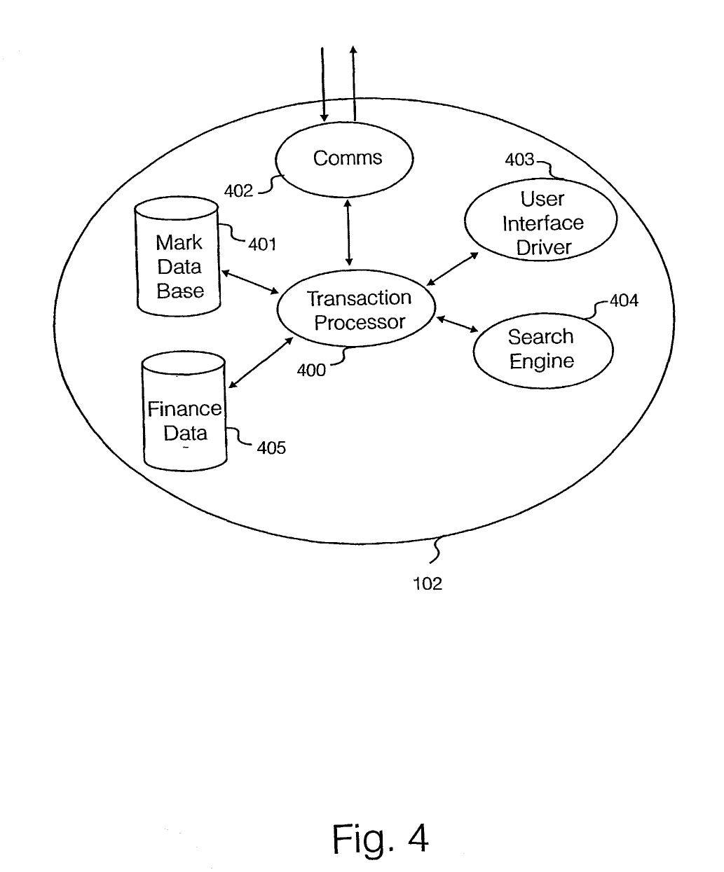

Referring to FIG. 4 herein, there is illustrated schematically a logical configuration of client terminal 102. The logical configuration comprises the hardware, firmware and software resources as described with relation to FIG. 3 configured as transaction processing engine 302.

Client terminal 102 comprises a transaction processor 400 which operates to receive trade mark application data via a communications module 402; a trade marks database 401 for storing details of trade mark applications; a finance database 405 for storing finance data relating to payment details of a customer; a search engine 404 for performing or obtaining trade marks searches; a user interface driver 403 for driving a plurality of displays on user interface 300; and a communications module 402 for communicating with a host server, and one or a plurality of governmental office servers 105-107, and sub-contractor terminals 103, 104. The transaction processor divides data in the customer instruction data received from host server 100 via communications modules 402 into various data categories including:

Trade mark detail data

Applicant data

Finance data

Instruction data

Details of the trade mark itself and the applicant data are stored in a trade marks database 401, which can be interrogated and monitored by human user. Finance data is stored in finance database 405 locally at the client terminal 102. Transaction processor 400 co-operates with user interface driver 403 to allow a human user to:

View details of transaction data as they are received from the host server 100;

Modify details of trade mark data, for example specification of goods and services;

Send details of mark and goods/services to search engine module 404 within the client terminal 102, or route details of the trade mark and specification of goods/services to a remote search engine, for example one provided by a third party;

Authorize and route trade mark application instruction data to one or a plurality of sub-contractor terminals, from the client terminal;

Route trade mark application instruction data to one or a plurality of govemmental/intergovemmental servers;

Control selection of sub-contractor terminals by entry/deletion of sub-contractor terminal data from the client terminal 102;

Alter an order of preference of sub-contractor terminals for routing of trade mark application instruction data to;

Enter data concerning local laws and trade mark procedures;

Enter and alter cost data for forwarding to host server 100;

Enter/delete country data for updating a list of countries presented at the host server 100.

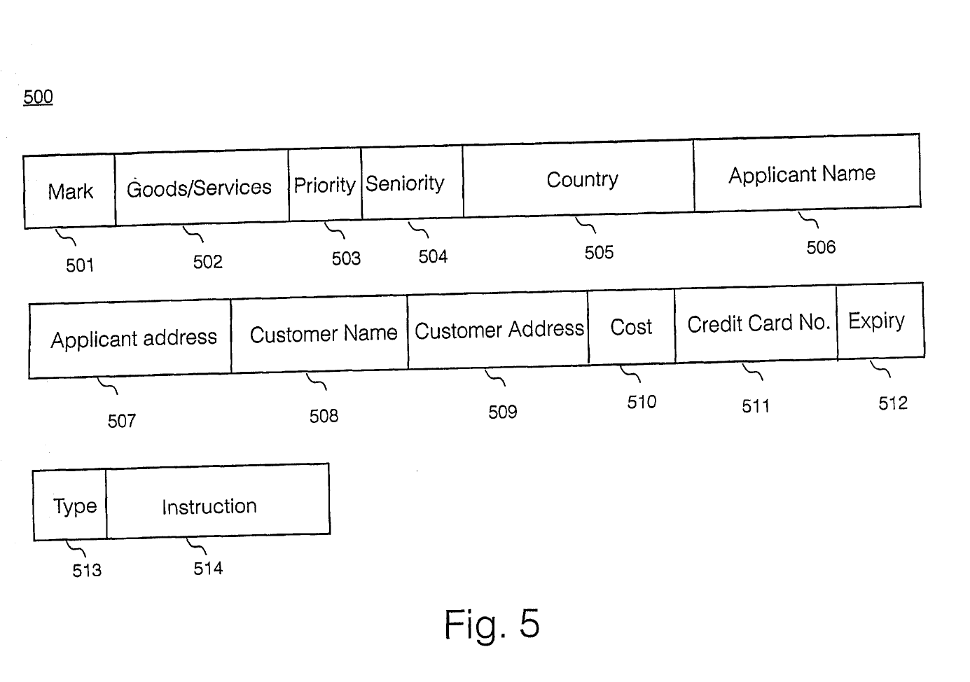

Referring to FIG. 5 herein, there is illustrated schematically a data flow diagram for transfer and handling of data at the client terminal 102 under control of the transaction processing engine 302. Customer instruction data is received from the host server 100 via a communications port 307 at the client terminal in the form of a data file. For example the data may be received as a PDF format file. The transaction processor 400 parses the data file to extract the different data types as follows:

Trade mark data: comprising details of the trade mark product itself, e.g. mark, goods/services list, priority details, seniority details.

Applicant data: comprising name, physical address, logical address, contact details, comprising telephone number data, fax number data, email address data.

Finance data: comprising credit card number, expiry date, type of card data.

Instruction data: comprising an instruction to file a trade mark application, an instruction to prosecute a trade mark application to registration, an instruction to perform a trade mark search, an instruction to file a trade mark conditional on a search result.

Trade mark data is stored in the trade mark database 401 and may be forwarded to a government office server or sub-contractor server in the form of trade mark application instruction data. The trade mark data may also be forwarded to the internal search engine 404, whereupon a trade mark search may be carried out upon the data, or alternatively routed to a remote trade mark search engine 110, for example one provided by a third party service provider.

The applicant data is stored in the mark/applicant database 401 and may also be forwarded to one or more government office servers and/or one or more sub-contractor terminals, contained in the trade mark application instruction data.

The finance data may be stored internally in the finance database 405, and sent to a finance house server in order for the finance house server to check and authorize payment from the credit card of a customer.

The instruction data determines a mode of operation of the client terminal 102 and how the client terminal processes a customer instruction data.

Referring to FIG. 5 herein, there is illustrated schematically a digital customer instruction data message received by client terminal 102 from host server 100 containing details of a registered trade mark application collected by the host server from a customer terminal 108, 109. The message comprises a plurality of fields including a mark field 501 containing data describing a trade mark; a goods/services field 502 containing data comprising a list of goods and services for which a trade mark application is to be filed; a priority data field 503 describing details of a priority trade mark application comprising priority country, priority date, priority mark and specification of goods and services; a seniority field 504 containing details of one or more trade mark applications from which seniority may be claimed comprising mark, goods/services, a seniority date, country; a country data field 505 comprising data describing at least one country in which a trade mark application is to be filed; an applicant name field 506 containing data describing details of an applicant name; an applicant address data field 507 comprising data describing an applicant address; a customer name field 508 comprising data describing a customer's name; a customer address data field 509 containing data describing a customer's address; a cost field 510 containing data describing a cost to the customer; a credit card number data field 511 containing a credit card number data; an expiry data field 512 containing details of an expiry date of a credit card and a type data field 513 containing data describing a type of credit card.

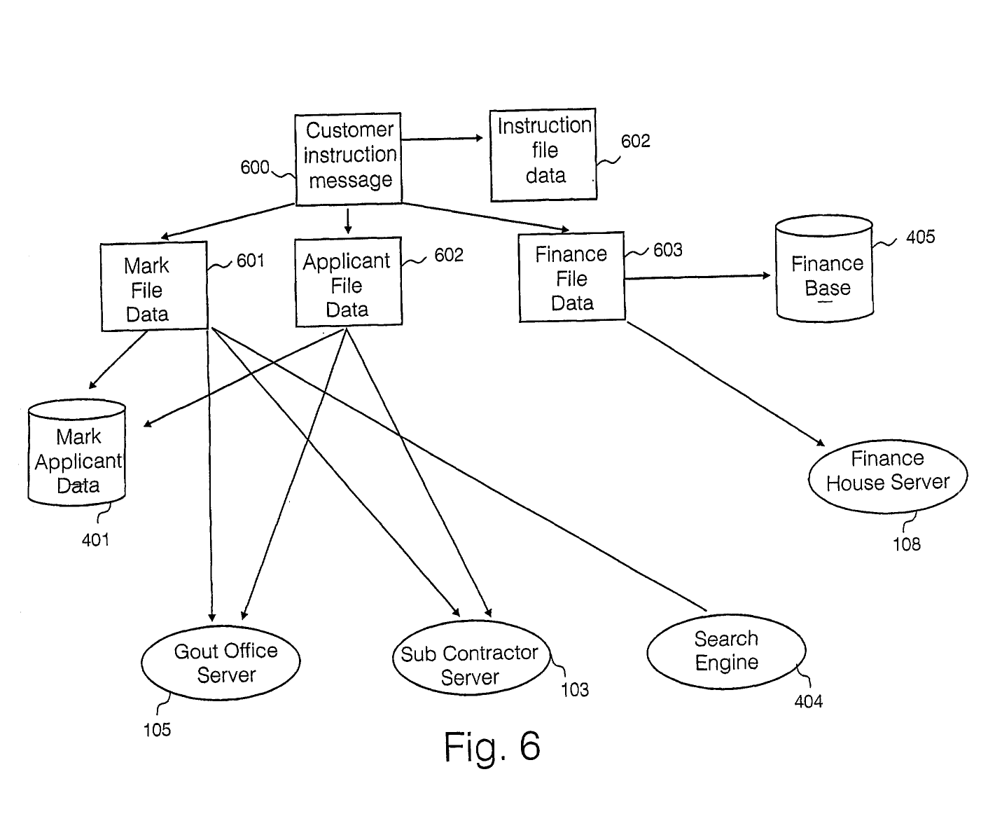

The customer instruction data from the host computer 100 is received by the client computer 102 and processed as described in FIG. 6 herein.

Referring to FIG. 6 herein, there is illustrated schematically a data flow diagram describing flows of data within the client platform 102. Customer instruction message 500, which contains enough information to complete a trade mark application filing at a governmental body, is received in step 701 in the form of a data file, for example a PDF file 600 as described herein before. The data file is parsed in step 702 to recover the various data fields described with reference to FIG. 6 herein. The customer instruction data file 600 is split into a mark data file 601, an applicant data file 602, a finance data file 603 and an instruction data file 602. The data may be viewed by a human operator at any time in step 703. The mark data file 601 contains mark data 501 goods/services data 502, priority data 503, seniority data 504 (where applicable) and country data 505. The applicant data file 602 comprises data describing applicant name 507, applicant address 508. The finance data file 603 comprises cost data 510, customer name data 509, customer address data 510, credit card number data 511, expiry data 512 and type data 513. The mark file data 601 is stored as separate fields in a mark database 401 and may be forwarded to a government office server 105, a sub-contractor server 104 and/or a search engine 404 for performing a trade mark search on the mark or may be sent to a remote search engine 410. The applicant data file 602 may be stored in the mark database 401, and also sent to a government office server 105 or subcontractor server 103, providing the government office server or subcontractor server with enough information, together with the mark data, to file a registered trade mark application. The finance data file 603 may be stored in finance database 405, and may be transmitted to a remote finance house server 108 in step 705. The finance house server checks the credit card details in step 706 and returns confirmation that the credit card is valid for the cost specified and sends this data back to the client platform 102 which receives it in step 707. If in step 706, the finance server finds that the cost amount received from the client terminal before the credit card specified in the finance data file is declined, after having performed the relevant checks, then in step 707 the message transmitted by the finance server and received by the client terminal is a ‘transaction declined message’ which results in the client terminal generating a message in step 708 which is sent to the customer terminal, informing the customer that the credit card details have been declined, and that the filing of the registered trade mark application will be aborted or suspended pending valid credit card details being received. However, a customer may re-enter valid credit card details, which may be sent in a customer instruction message as illustrated in FIG. 5 and which if passed by the finance server 108 after having been received from the client terminal 102, will result in continuation of the trade mark application filing.

In step 709, provided a valid transaction clearance message has been received from the finance house server by the client terminal 102, if a search has been instructed in the search instruction field 514 of the transaction message 500, then details of the mark, country and specification of goods are sent to the search engine 404 and the search is carried out on the trade mark. Search engine 404 may perform the search on a database, or the client terminal may interrogate a remote searching facility via communications interface 402. A result is obtained from the database within the client terminal, or from the remote search agent 110, and if the result is consistent with filing of the application is step 711, then details of the mark data file and applicant data file are forwarded to the appropriate government office server or subcontractor server in step 714. However, if the results of the trade mark search are not consistent with filing an application, because the search shows that the mark is already applied for, or registered, for the same goods and services in a particular country, then if the filing of the trade mark application depends upon the mark not already being applied for or registered for the same goods and services in that country then the search result is forwarded to the customer terminal in step 713 and filing of the trade mark application is aborted. The customer may re-instruct filing of the trade mark application at a later date. However, if the customer instructs to file a trade mark application irrespective of the search result, and in step 711 a search result inconsistent with filing of the trade mark application is obtained, in step 712, irrespective of the result of step 711 then the mark data file and applicant data file may be forwarded to a government office server or subcontractor server 105, 103 respectively with an instruction to file a registered trade mark application for that mark. In step 715. The government office server or agent server, having generated confirmation details in the form of an electronic filing receipt specifying mark, goods/services, filing date, application number, sends a filing confirmation message, in the form of a data file, to the client terminal 102, which is received by that terminal. In step 716, the client terminal 102 generates a second filing confirmation message, which is sent back to the originating customer terminal 108, 109, or a customer terminal specified by the customer in the original instruction message 500.

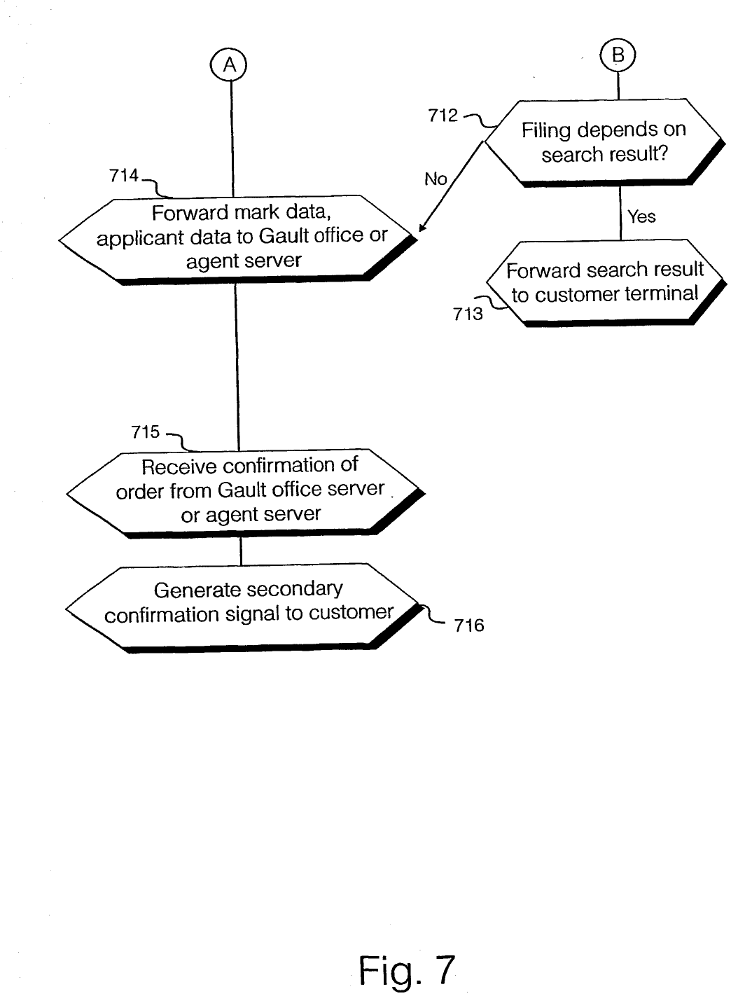

Referring to FIG. 8 herein, there is illustrated schematically components of host server 100. The host server comprises a user interface 800 comprising a visual display unit, a keyboard and a pointing device, e.g. a mouse, enabling human interaction for management and monitoring purposes and for modification of programming; a transaction engine 801, operating to display web pages in a viewable format, for example HTML, displaying information to a plurality of customers, receive data and instructions from one or a plurality of said customer terminals, and forward collected data to said client terminal 102; an operating system 802, for example Windows 2000 or similar; a memory area 803 including random access memory, read-only memory and hard disk memory; one or more processors 804; a plurality of drivers and ports 805 including drivers for data back-up, e.g. tape streamer drivers; and one or more modems for communicating with the customer terminals and client terminal 102.

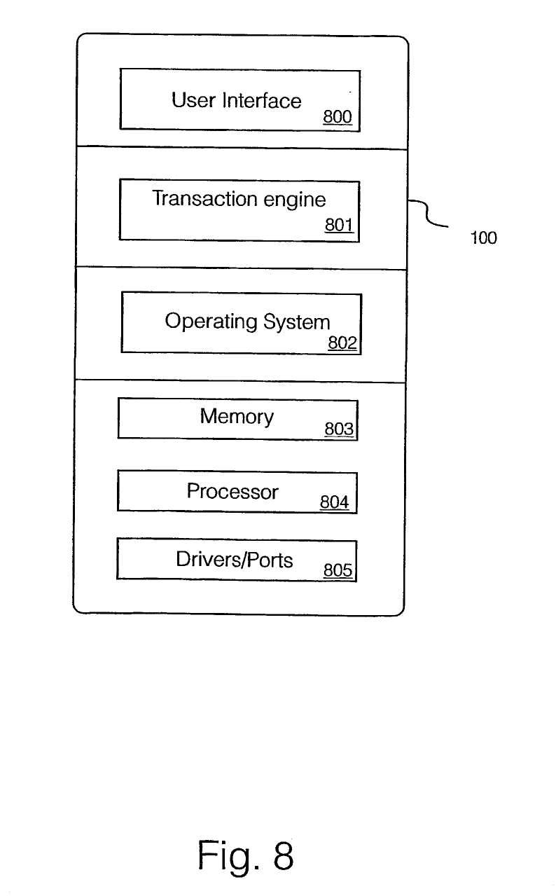

Referring to FIG. 9 herein, there is illustrated schematically a logical architecture of host server 100. Transaction engine 801 comprises a transaction processor 900 for processing transaction data received from a customer terminal 108; a web server interface 901 for interfacing with the plurality of customer terminals 108 and one or more client terminals 102; a communications port 902 connected to the transaction processor and web server, allowing direct communication with other computer entities such as client terminal 102 and one or more customer terminals 108; a law database 903 for storing data describing trade mark laws and procedures; a country database 904 for displaying a list of country codes for display upon a web site generated by the web server 901; a goods/services database 905 for storing a list of the international classification of goods and services, and/or national lists of goods and services for each of a plurality of individual countries; a costs database 906 for storing data relating to costs of trade mark applications in a plurality of countries.

The web server 901 provides a web site which can be viewed by a web is browser on a customer terminal 108.

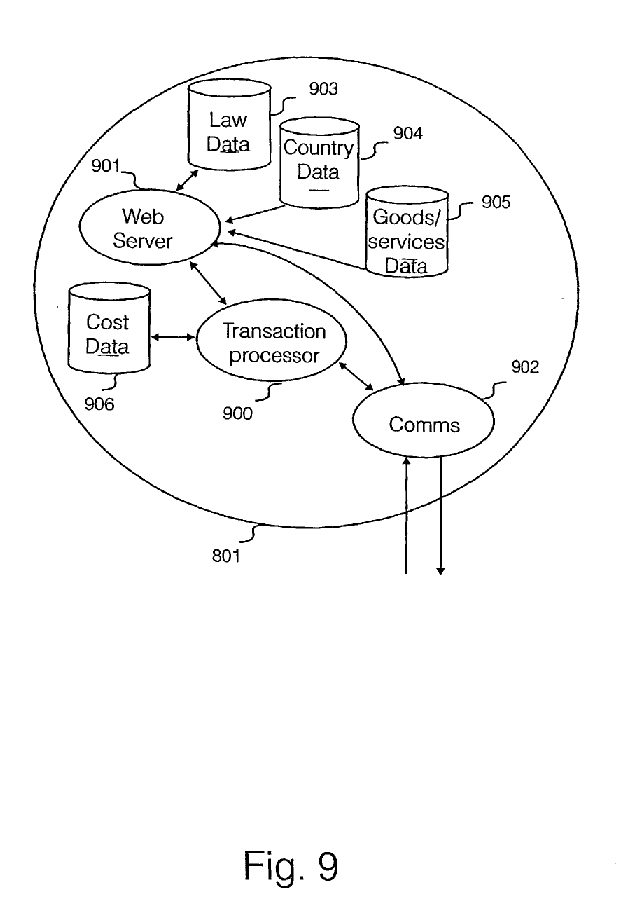

Referring to FIGS. 10 to 13 herein, there are illustrated examples of pages which are viewable by a web browser and which display on a customer terminal user interface, the pages being generated by web server 901.

In FIG. 10, a home page display may occupy a full screen of a visual display unit, for example a 17″ or 19″ screen. The display comprises a border region 1000 which extends around an edge of a display area 1001. The border area displays information which is common to all pages on the web site, and which is always present and readable on the web site.

A page area 1002 contains selectable pages, changeable by customer navigating different pages on the web site. Individual pages within the web site may be scrolled up or down within the page display region 1002.

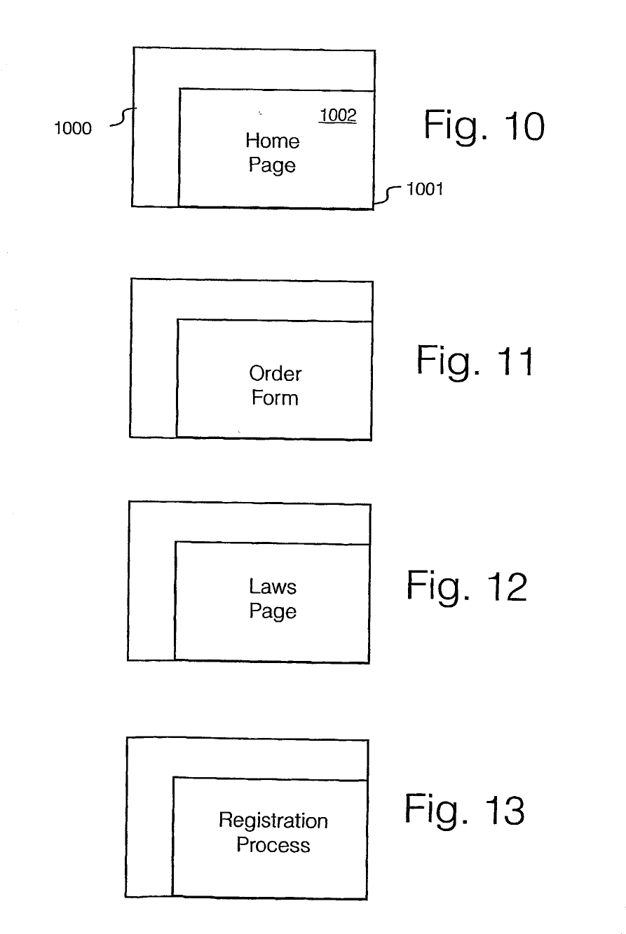

Referring to FIG. 11, there is shown schematically an order form page comprising part of the web site displayed by web server 901.

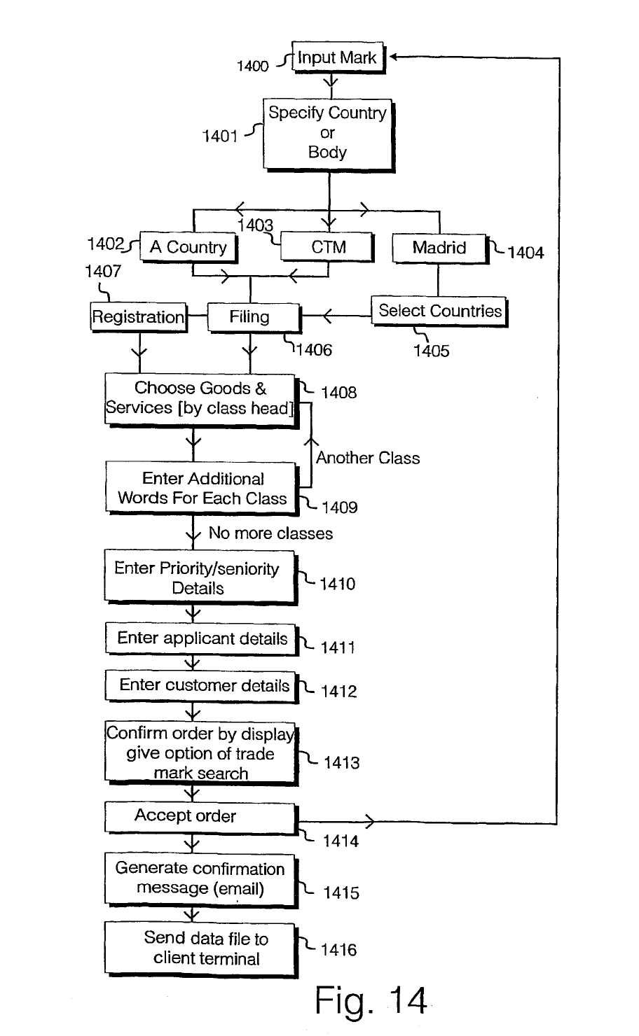

Referring to FIG. 12 herein, there is illustrated schematically a law page display generated by web server 901. The law page displays law data which summarizes different procedures and laws in a plurality of countries. Examples of such procedure and laws may include the following:

Whether or not an official search procedure is followed in individual countries, or whether trade mark applications are not searched

Whether an official examination procedure exists in each of a plurality of countries.

Whether an opposition procedure exists as part of a trade mark registration process in each of a plurality of countries.

If an opposition procedure exists, a period during which a trade mark application is open to opposition by third parties prior to registration.

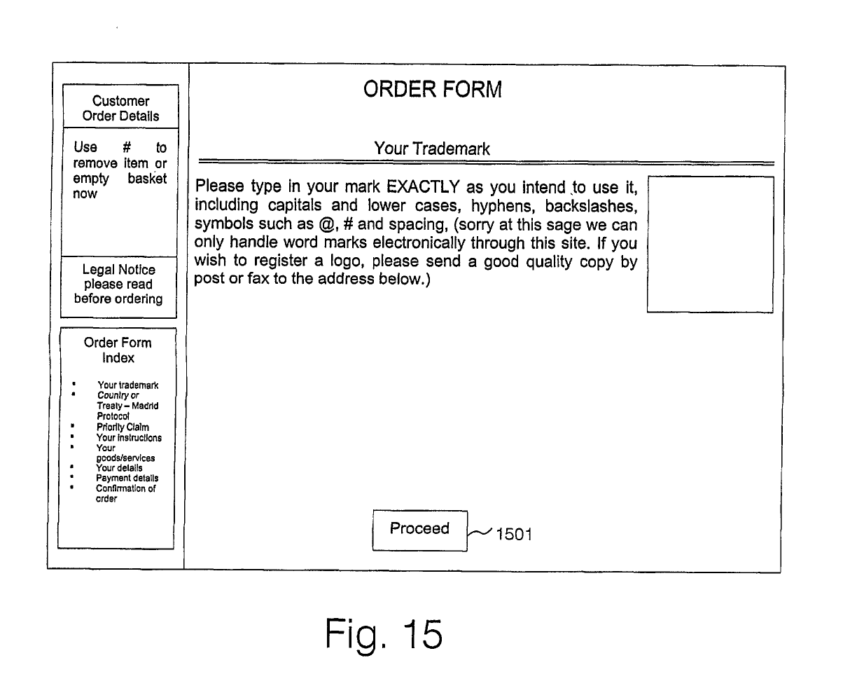

Referring to FIG. 13 herein, there is illustrated schematically a registration process display generated by web server 901. The registration process page displays data describing a general registration process generic to one or a plurality of countries for obtaining a registered trade mark.

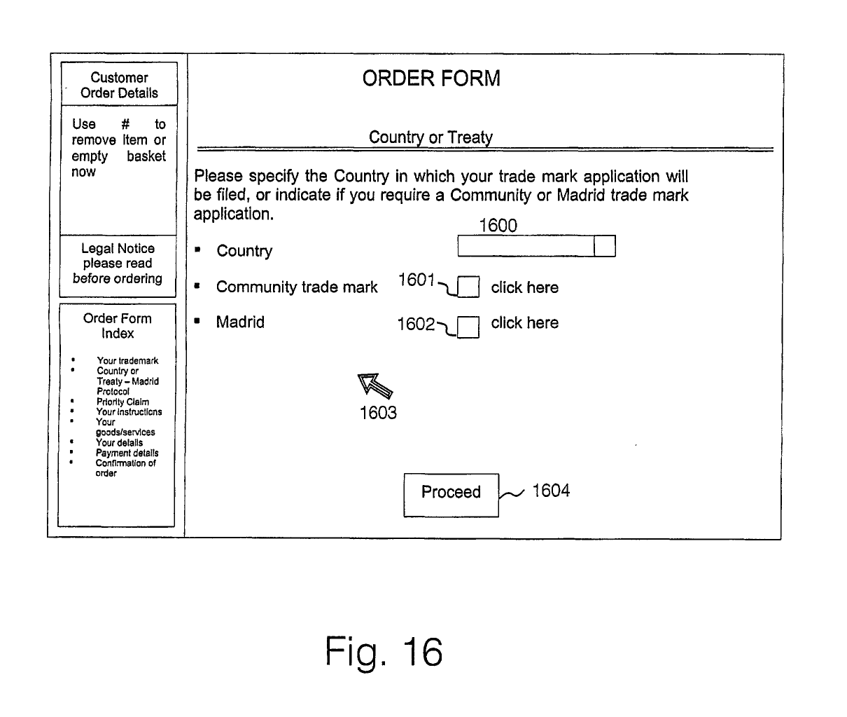

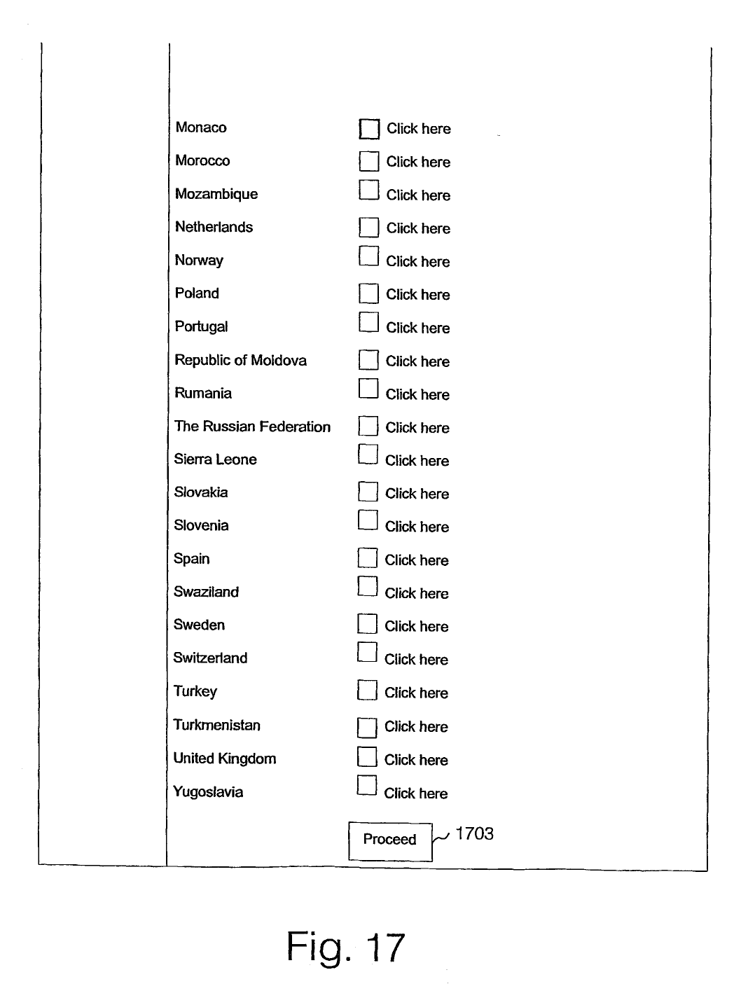

Referring to FIG. 14 herein, there is illustrated schematically a mode of operation of server platform 100 for processing a registered trade mark application entered as data at a customer terminal via a web browser resident on the customer terminal. In step 1400 the customer enters through the user interface of the customer terminal details of the trade mark as it is to be registered. Typically, for a word mark, this will include a word in a conventional typeface, and may include characters such as ?, *, #, @, !, %, &. The characters may be input as capitals or a mixture of capitals and lowercase. On correctly entering the details of the mark, the customer activates a ‘proceed’ icon 1501 to proceed to the next section of the order form as shown in FIG. 16 herein. In step 1401, the customer specifies a country or region for filing of a trade mark application. A country/treaty section of the order form is displayed by web server 901, having data entry fields for entering a country 1600, selecting a regional trade mark system such as the community trade mark system 1601, or a Madrid Protocol trade mark application 1602. The country selection box 1600 comprises an icon-activated dropdown menu listing a plurality of countries. A customer selects a particular country by scrolling to that particular country, and activating selection of that country by, for example, a double-clink on the pointing device whilst a pointer icon is over the selected country. The user can select in step 1402 any one of a plurality of countries, in step 1403 a community trade mark by activating the community trade mark selection box 1601, or a Madrid trade mark application by selecting the Madrid Protocol selection icon 1602 in step 1404.

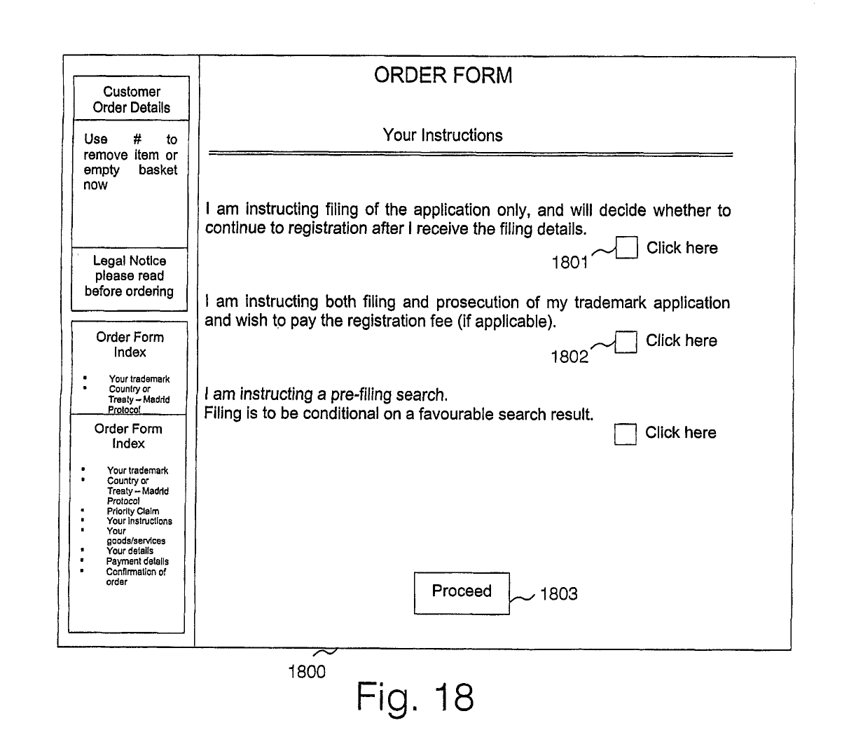

If the user selects an individual country from the country selection box 1600, or the community trade mark box 1601, the user then activates a proceed icon 1604 by placing the pointer icon 1603 over the proceed icon and double-clicking the pointing device. However, if the user selects a Madrid application by activating selection icon 1602 for the Madrid application, the page display regenerates to display a Madrid Protocol section as illustrated schematically with reference to FIG. 17 herein.

Referring to FIG. 17, a Madrid Protocol country selection page display 1700 comprises a plurality of selection boxes, one per each country within the Madrid system. A customer selects which countries are to be designated within a Madrid-type trade mark application by moving a pointer icon 1701 over a selection box, for example 1702 and clicking the pointer icon over the selection icon. When selected, a ‘tick’ icon appears in the selection icon. The user may move over as many selection icons as necessary, ticking each icon in order to select a corresponding respective country in the Madrid application. The user may delete that selection by, again, clicking over the corresponding respective selection icon for a country, in which the tick toggles between a tick and blank box.

Once the customer has selected all countries for the Madrid application, the customer then activates a proceed icon by means of the pointer icon 1703 and pointing device as described herein above.

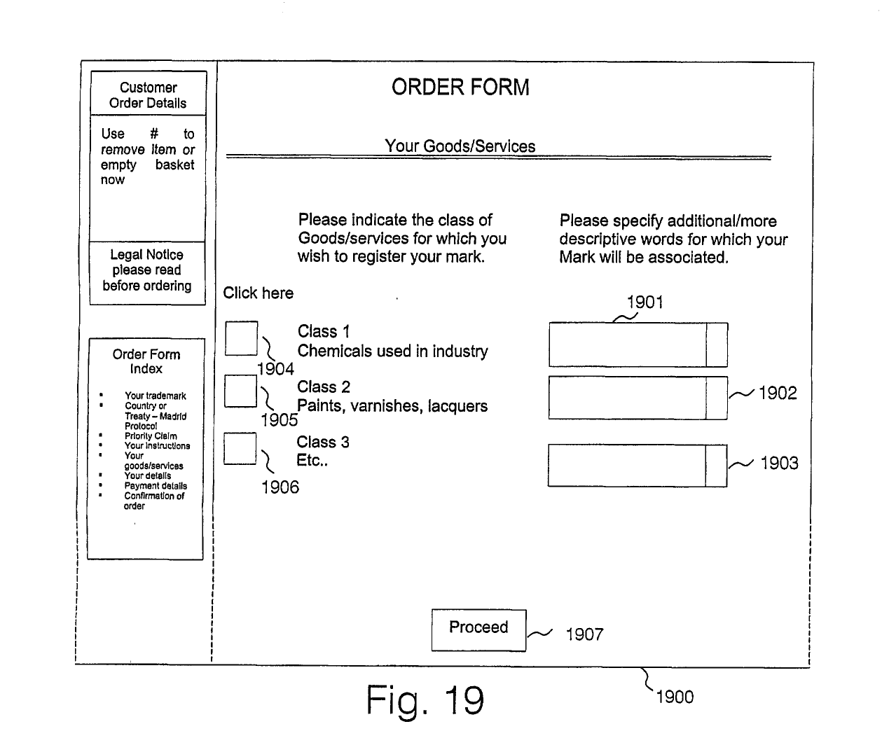

Having selected countries in step 1405, transaction engine proceeds to seek instructions from the customer by display of a customer web page similarly as illustrated in FIG. 18 herein. A section 1800 of the order form is provided for receiving instructions at the customer terminal by selecting a first selection box 1801 by positioning a pointer icon as previously described, for filing an application only and/or by selecting a second selection icon 1802 for instructing both filing and registration of a trade mark application. Once the user has completed one or two instruction selection boxes 1801, 1802, the customer may proceed by selecting a proceed icon 1803, similarly as herein before described.

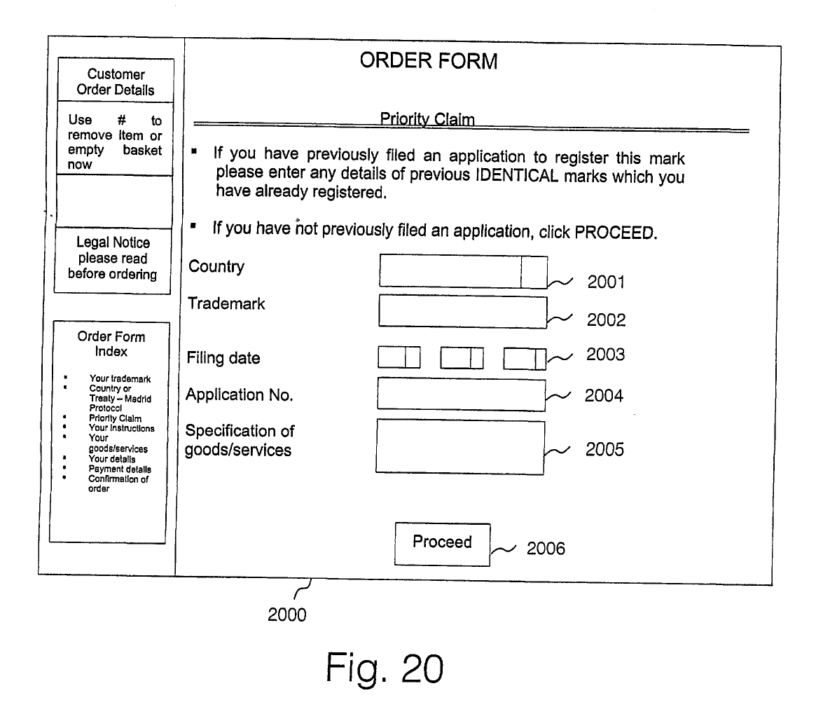

The order form proceeds to a goods/services section as illustrated in FIG. 19 herein in step 1408 in which a customer can select goods and services by classification heading from the order form web page displayed. A list of goods and services, stored in the goods/services database 905, is presented as a series of dropdown menus 1900-1902. Selection of items from the list of goods/services are made as herein before described by activation of a pointing device, and placing a pointer icon over the relevant dropdown menu of relevant goods and services in the dropdown list. For each class of goods and services there is a further selection icon 1903-1905 which can be activated for selection of that particular class. If any of the goods and services selected in the dropdown menu selection box in 1900-1902 are selected, then a ‘tick’ icon may be generated and appear in the corresponding respective selection boxes 1903-1905, indicating that goods or services in that class have been selected. The actual selection is as per the items selected on the dropdown list. The user may select as many goods or services as required from the dropdown menus, or alternatively may tick the class selection icons 1903-1905 to select all goods in a particular class. The customer may scroll up and down the individual dropdown lists until they are content with their selection, re-visiting any class list menu, prior to pressing a proceed icon 1906 to proceed to a next section of the order form page.

In step 1409 additional words for each class which are not explicitly listed in the dropdown menus may be added by a customer by typing the words in the selection boxes 1900-1902.

In step 1410, there is displayed a priority claim/seniority claim data entry page containing a mark data entry box 2000 for entering details of priority or seniority trade marks, a filing date data entry box 2001 for entering details of date including year, month and day of the priority or seniority filing; an application number data entry box 2003 for entering details of the priority or seniority application number and a box for typing in a specification of goods/services 2004 of the priority of seniority application.

Entering of priority details is not obligatory, and the order form will proceed without entry of such data by pressing a proceed icon 2005. However, if a customer correctly fills in the filing date and country fields 2002, 2001, then this will suffice for making a claim to priority.

The country field 2001 contains a dropdown menu providing a list of individual countries. Similarly, each day, month or year box of the filing date selection box 2003 may contain a dropdown menu listing year, month or day as appropriate.

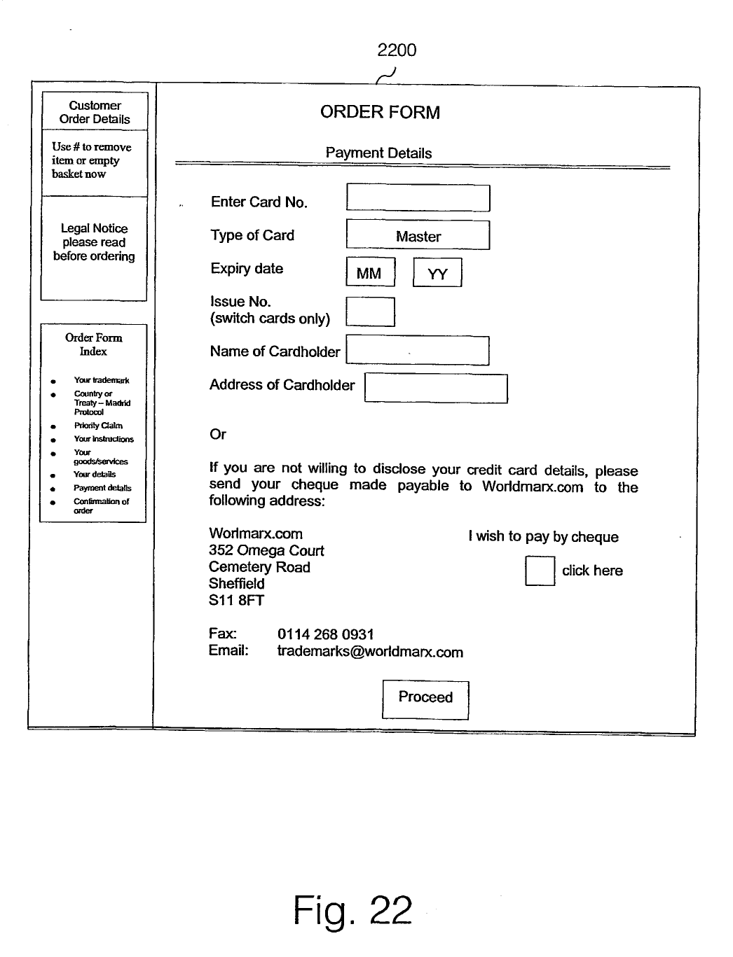

In step 1411, the order form proceeds to a applicant details section as illustrated schematically in FIG. 21. A detailed section 2100 of the order form comprises data entry boxes for name 2101, postal address 2102, country 2103, postcode 2104, email address 2105, telephone number 2106, and fax number 2107 for the applicant.

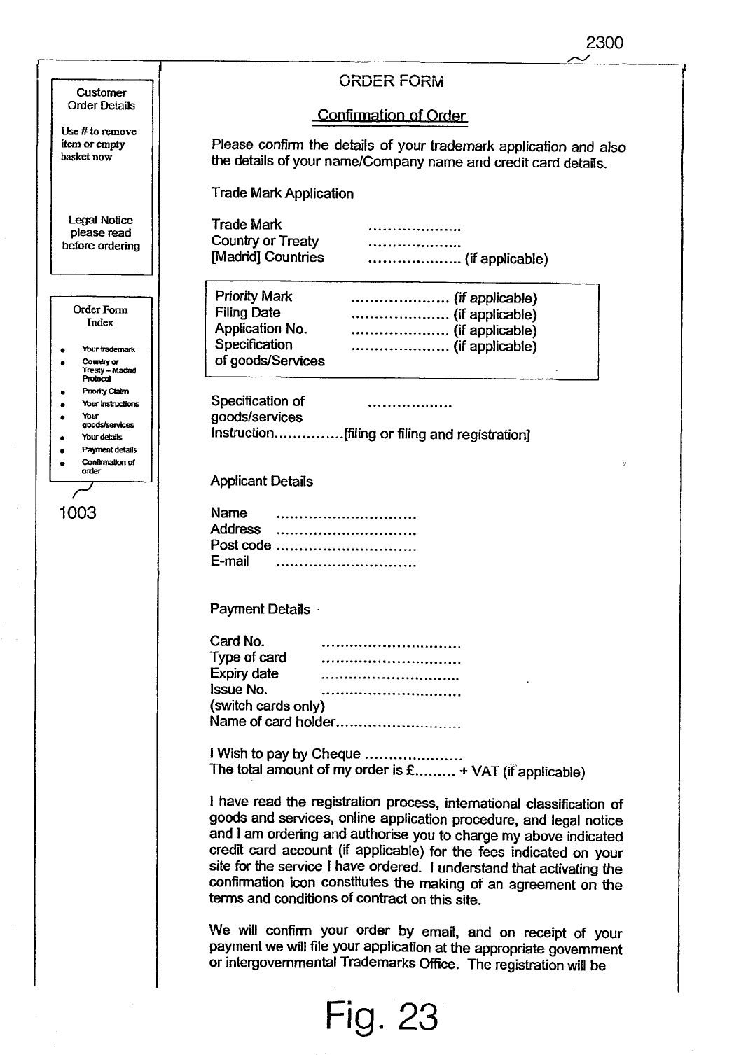

In step 1412 customer details including payment details are entered. Customer details are entered by means of a similar order form section display as described with reference to FIG. 22.

Data entered comprises a credit card number, a type of card, an expiry date of the card and issue number of a card, a name of the cardholder and an address of the cardholder.

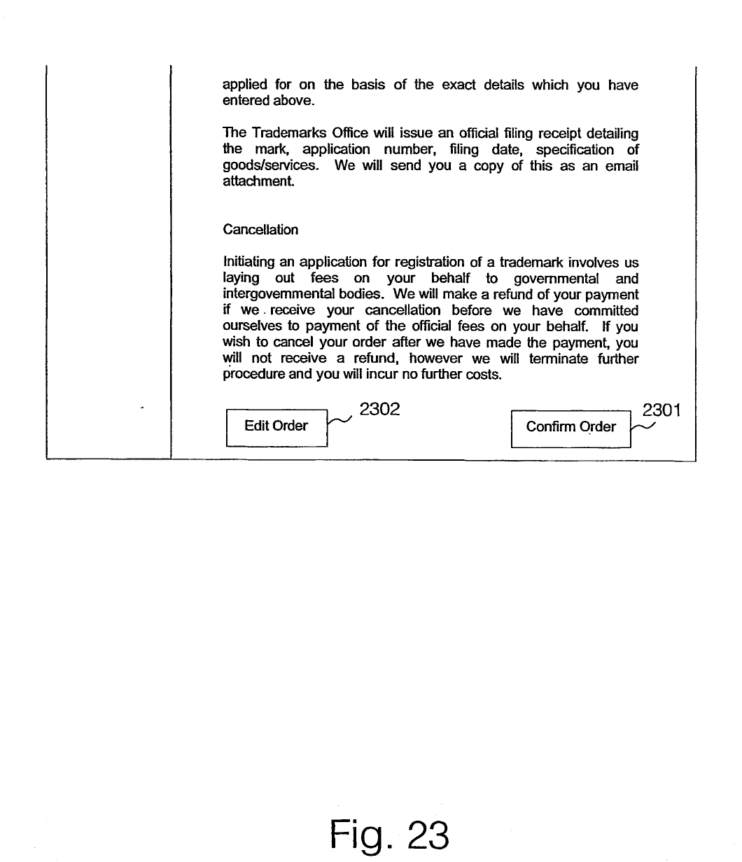

In step 1413, the host server confirms an order by displaying a confirmation of order section to the order form page as illustrated schematically in FIG. 22 herein. The confirmation of order gives a visual display, accessible by web browser at a customer terminal including the collected mark data, applicant data and finance data and instruction data as illustrated in FIG. 23 herein.

The mark details comprises details of the mark, details of the country or countries, priority mark including priority date, application number and specification of goods and services of the priority mark if applicable, a list of the goods and services which were previously filled in by the customer in step 1408, and confirmation of the instruction. i.e. whether the application is to be filed or filed and proceeded to registration. Applicant details include name, address, postcode, email, fax and telephone number of the applicant. Finance details include credit card number, type of card, expiry date, issue number and name of cardholder. There is also confirmation of the total amount of the order.

A customer confirms the order which constitutes acceptance of a legal contract by activating a confirm icon order 2301. If, after reviewing visually the customer wishes to change anything, all details displayed can be changed in the confirmation of order section by editing the details. A customer may edit the order on the confirmation of order section after activating an edit order icon 2302. If the customer wishes to edit significant details such as the specification of goods, services, the customer may skip back to the goods/services section 1900 of the order form by placing the icon over a menu list in the frame portion 1000 of the website which takes the customer back to the relevant section of the order form page. Similarly, by activating the order form index 1003, the customer may change details such as selection of countries states, the mark, the priority details, or any other items filled in on the order form.

After having activated the confirm order icon 2201, which constitutes acceptance of an order in step 1414, host server generates an accept order confirmation page as illustrated with reference to FIG. 23 herein. This confirms visually to the customer at the customer terminal that the order has been accepted by the web server 100.

The web server then proceeds to generate a confirmation message in the form of an email in step 1415, which is sent to the customer terminal as paper confirmation, in addition to the visual confirmation provided by the confirmation page display of FIG. 23.

The web server 100 compiles the information of the order form into a data file message as illustrated with reference to FIG. 5 herein, which is transmitted to the client terminal 102. The client terminal 102 then processes the order as herein before described.

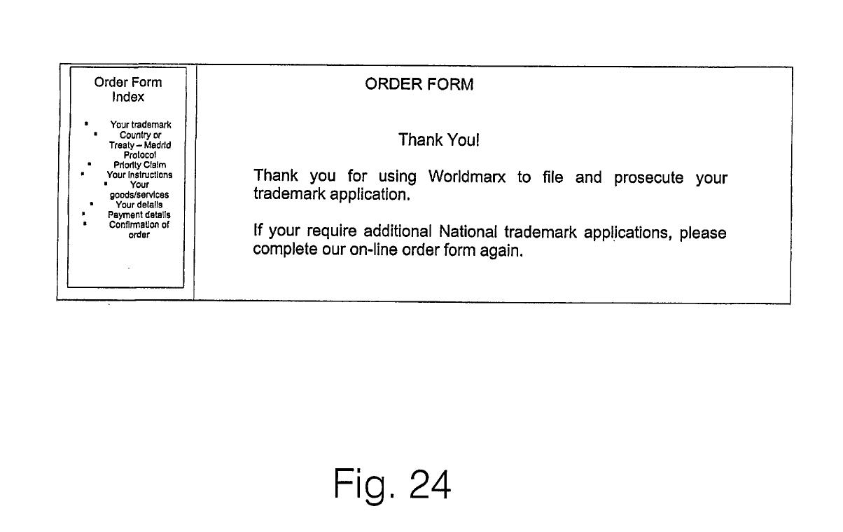

Once the customer has entered all details on the order form, and has activated proceed icon 2301, the web server generates an order form confirmation message as illustrated in FIG. 24, which is viewed by a web browser at the client terminal.

1. A method of processing transaction data relating to trade marks via at least one computer entity, said method comprising the steps of:
displaying country data describing at least one country in which a trade mark application may be filed;
displaying classification data describing a list of goods and services classified into a plurality of different categories;
displaying price data relating to at least one transaction price for performing a service in relation to a said trade mark.

2. The method as claimed in claim 1, further comprising the steps of:
selectively inputting individual items of said classification data at a user interface of a said computer entity;
inputting trade mark data describing a trade mark, at a user interface of a said computer entity;
inputting applicant data specifying an applicant of a said trade mark at a user interface of a said computer entity;
entering financial data describing an account number of a customer at a user interface of a said computer entity; and
generating a confirmation message confirming said mark data, classification data, applicant data, and price data.

3. The method as claimed in claim 2, further comprising the step of:
sending said confirmation message between a plurality of individual said computer entities.

4. The method as claimed in claim 1, wherein a said computer entity comprises a server computer entity and another said computer entity comprises a client terminal computer entity, said method further comprising the steps of:
said server computer entity transmitting said mark data, classification data, price data, applicant data and finance data to a receiving client terminal.

5. The method as claimed in claim 1, further comprising the steps of:
filtering said mark data, classification data, price data and applicant data for storage in a database maintained at a said computer entity.

6. The method as claimed in claim 1, further comprising the step of:
transmitting said mark data, classification data, applicant data to a receiving computer entity of an official trade marks office as an electronic message.

7. The method as claimed in claim 1, further comprising the step of:
receiving an electronic filing receipt from a computer entity of an official trade marks office, said electronic filing receipt comprising data selected from the set:
application number data;
filing date data;
applicant data;
priority claim data;

8. The method as claimed in claim 1, wherein said classification data is presented as a plurality of distinct icons, each icon relating to a corresponding respective class of goods/services.

9. The method of processing transaction data relating to trade marks via a system of computer entities, said method comprising the steps of:
displaying country data describing at least one country in which a trade mark application may be filed;
displaying classification data describing a list of goods and services classified into a plurality of different categories;
displaying price data relating to at least one transaction price for performing a service in relation to a said trade mark;
selectively inputting individual items of said classification data at a user interface of a said computer entity;
inputting trade mark data describing a trade mark, at a user interface of a said computer entity;
inputting applicant data specifying an applicant of a said trade mark at a user interface of a said computer entity;
entering financial data describing an account number of a customer at a user interface of a said computer entity;
generating a confirmation message confirming said mark data, classification data, applicant data, and price data;
sending said confirmation message between individual said computer entities

10. The method as claimed in claim 9 further comprising the steps of:
a said server computer entity being a server computer entity transmitting said mark data, classification data, price data, applicant data and finance data to a receiving client terminal.

11. The method as claimed in claim 9, further comprising the steps of:
filtering said mark data, classification data, price data and applicant data for storage in a database maintained at a said computer entity.

12. The method as claimed in claim 9, further comprising the step of:
transmitting said mark data, classification data, applicant data to a receiving computer entity of an official trade marks office as an electronic message from a said computer entity.

13. The method as claimed in claim 9, further comprising the step of:
receiving an electronic filing receipt from a computer entity of an official trade marks office, said electronic filing receipt comprising data selected from the set:
application number data;
filing date data;
applicant data;
priority claim data;

14. The method as claimed in claim 9, wherein said classification data is presented as a plurality of distinct icons, each icon relating to a corresponding respective class of goods/services.

15. A computer entity configured for generating a trade mark application order form display, and configured for receiving customer instruction data input, said customer instruction data relating to the filing of a trade mark application, said computer entity comprising:
at least one processor;
at least one communications means;
memory storage means storing at least one database, a countries database, storing a country data describing a list of countries;
a goods/services database containing a list of goods and services arranged according to at least one classification system;
a cost database comprising a list of costs associated with filing a registered trade mark application in each of a plurality of said countries.

16. The computer entity as claimed in claim 15, comprising:
a web server configured to display a said order form web page;
wherein said web server operates to:
display said country data comprising a list of a plurality of individual countries;
display said cost data describing a cost of filing a registered trade mark application in at least one of said countries;
display said list of goods and services arranged according to a plurality of classes according to a classification system;
and said computer entity operates to:
receive input data describing at least one said country;
receive input data describing a list of goods/services selected according to said displayed goods/services;
receive input data describing a trade mark;
compile said country data, goods/services data, and mark data into a data file; and
transmit said data file via said communications means.

17. The computer entity as claimed in claim 15, further configured to:
display a web page containing law data describing a plurality of countries, and for each said country displaying data selected from the set;
whether an official trade mark search procedure is followed in said country;
whether an official trade mark examination procedure is followed in said country;
whether an official opposition procedure is followed in said country;
a period for an official opposition procedure in said country;
whether legalisation of documents in connection with a trade mark application is required in said country;
whether notarisation of documents in connection with a trade mark application is required in said country.

18. A client terminal computer entity capable of receiving a customer instruction data instructing filing of a registered trade mark application, said client terminal computer entity comprising:
at least one processor;
at least one data processor,
at least one communication means;
a memory means
at least one database; and
a transaction processor means; wherein said client terminal computer entity is configured to receive a customer instruction data message comprising:
data describing a country in which a trade mark application is to be filed;
data describing a list of goods and services classified into a plurality of different classification categories; and
data describing a trade mark.

19. The client terminal as claimed in claim 18, configured to receive a customer instruction data message comprising:
data describing an applicant for said registered trade mark application;
data describing financial details of a customer including account number data and customer name data; wherein
said client terminal computer entity operates to:
store said trade mark data and applicant data in an internet database;
send said finance data via said communication means to a third party computer entity;
receive a finance confirmation signal confirming that a customer's financial details are valid for a specified cost amount; and
if said valid customer finance details are received, generate a trade mark application instruction data for instruction of filing a registered trade mark application at a trade mark office.

20. The computer entity as claimed in claim 18, further configured to:
send trade mark application instruction data for instructing a registered trade mark application to a government office computer entity electronically.

21. The computer entity as claimed in claim 18, further configured to:
send trade mark application instruction data for instructing a registered trade mark application to a third party subcontractor computer entity.

22. The computer entity as claimed in claim 18, further comprising a user interface having a visual display device an a keyboard data entry means, said user interface allowing a human user to monitor and inspect trade mark application instruction data for instructing a registered trade mark application and said customer instruction data.

23. The client terminal computer entity as claimed in claim 18, further configured to:
send a search instruction data to an external third party engine computer entity.

24. The computer entity as claimed in claim 18, further comprising:
a search engine for performing a trade mark search.

25. A computer entity configured for displaying a trade mark application order form display, and configured for receiving customer instruction data input at a remote location, said customer instruction data relating to the filing of a trade mark application, said computer entity comprising:
at least one processor;
at least one communications means;
memory storage means storing at least one database, a countries database, storing a country data describing a list of countries;
a goods/services database containing a list of goods and services arranged according to at least one classification system;
a cost database comprising a list of costs associated with filing a registered trade mark application in each of a plurality of said countries;
a web server configured to display a said order form web page;
wherein said web server operates to:
display country data comprising a list of a plurality of individual countries;
display cost data describing a cost of filing a registered trade mark application in at least one of said countries;
display list of goods and services arranged according to a plurality of classes according to a classification system;
input data describing at least one said country;
input data describing a list of goods/services according to said displayed goods/services;
input data describing a trade mark;
compile said country data, goods/services data, and mark data into a data file; and
transmit said data file via said communications means.

27. A client terminal computer entity capable of receiving a customer instruction data instructing filing of a registered trade mark application, said client terminal computer entity comprising:
at least one processor;
at least one data processor;
at least one communication means;
a memory means
at least one database;
a transaction processor means; wherein said client terminal computer entity is configured to;
receive a customer instruction data message comprising:
data describing a country in which a trade mark application is to be filed;
data describing a list of goods and services classified into a plurality of different classification categories;
data describing a trade mark;
data describing an applicant for said registered trade mark application;
data describing financial details of a customer including account number data and customer name data; wherein
said client terminal computer entity operates to store said trade mark data and applicant data in an internet database;
send said finance data via said communication means to a third party computer entity;
receive a finance confirmation signal confirming that a customers financial details are valid for a specified cost amount;
if said valid customer finance details are received, generating a trade mark application instruction data for instruction of filing a registered trade mark application at a trade mark office.

27. An internet based service system comprising:
a host server computer apparatus; and
communication means, said communication means being configurable to allow communication between said host server computer apparatus and a plurality of logical entities, whereby in use said service system allows a user to file a plurality of trade mark applications at a plurality of international offices and/or said service system provides said user with the facility to conduct a trade mark search,
wherein said service system further comprises:
a suitable user interface,
said filing of said trade mark application being undertaken by a sub contractor.

28. An internet based service system as claimed in claim 27, wherein said logical entities comprise a customer terminal, a host server, an internet service provider, a sub contractor terminal, a government or intergovernmental office server and a finance company server.

29. An internet based service system as claimed in claim 27, wherein said communication means comprise an ISDN and/or a virtual private network and/or the internet and/or wireless links.

30. An internet based service system as claimed in claim 27, wherein said host server computer apparatus comprises a transaction processing engine, an operating system, a memory facility, a processor, a plurality of disc drives, a plurality of ports and a plurality of software.

31. An internet based service system as claimed in claim 27, wherein said user interface comprises a plurality of interactive internet web pages, said web pages being configurable to allow said user to interact with a plurality of boxes and/or drop down menus.

32. An internet based service system as claimed in claim 27, wherein said sub contractor is a firm of trade mark agents or a firm of lawyers, or a trade mark agency or a trade mark agent or a trade mark attorney or a lawyer or a trade mark lawyer.

33. An internet based service system as claimed in claim 27, wherein said international offices comprise a government or intergovernmental trade mark office said government or intergovernmental trade mark office being capable of receiving and processing said trade mark applications.

34. An internet based service system as claimed in claim 27, wherein said trade mark applications comprise said user's disclosure of the trade mark, the goods/services to which the trade mark is to be associated, the country in which the trade mark application will be filed, and/or any details of priority claim relating to an earlier application.

35. An internet based service system as claimed in claim 27, wherein said trade mark applications comprise said user's disclosure of information, said information being suitable to establish a filing date under the protocol relating to the Madrid agreement concerning the international registration of marks (adopted at Madrid on Jul. 27, 1989).

36. An internet based service system as claimed in claim 27, wherein said trade mark applications comprise said user's disclosure of information, said information being suitable to establish a filing date, at the Community Trade Mark Office or, the Office of Harmonization in the Internal Market (trade marks and design).

37. An internet based service system configurable to allow a user to provide instruction for the filing of a plurality of trade mark applications at a plurality of international offices, whereby said service system is further configured to process data relating to:
a mark;
goods/services;
a priority date;
a country;
an international treaty;
cost;
applicant name;
applicant address;
customer name;
customer address;
credit card number;
expiry date; and
type of card.

38. A method of instructing the filing of trade mark applications using an internet based service system, said service system comprising a host server computer apparatus, communication means and a suitable user interface, said method of filing of said trade mark application comprising the steps of:
receive transaction data;
transaction data to recover mark data, applicant data and, finance data;
view data on display;
store mark data and applicant data or;
forward finance data to finance server and/or;
check confirmation signal from finance server;
forward mark data to search engine;
receive search results and check;
forward mark data and, applicant data to government office or agent server;
receive confirmation of order from government office server or agent server;
generate secondary confirmation signal to customer.

39. An internet based service system comprising a host server computer apparatus;
communication means and;
a suitable user interface;
said user interface comprising a home page, information pages and, an order form.

40. An internet based service system as claimed in claim 39 wherein, said user interface comprises menus, said menus being configurable whereby in use a user may select an item from said menu, said item thereby being a constituent of a trade mark application.

41. A method of instructing the filing of trade mark applications using an internet based service system, said service system comprising a host server computer apparatus, communication means and a suitable user interface, said method of filing of said trade mark application comprising the steps of:
input mark;
specifying country or body; said body being an international treaty;
where a country or CTM are specified, said user selects filing or filing and registration;
whereby said user selects Madrid at specify country or body step, said user thereby selects countries;
said service system, via said user interface, prompts said user to specify goods/services at choose goods and services step; whereby there is provided on said user interface means to enter additional words for each class;
said user may then specify another class in addition to previous selections at stop choose goods/services;
where no more classes are required by said user, said user must confirm order at confirm order step or alternatively proceed to edit previous selections;
where order is confirmed, said user is the recipient of an email, said email thereby confirming said order, at email confirm order step;
whereby on receipt of said email said users account is debited at debit account step;
where method of payment by said user is via direct debit by other payment means a sub contractor will proceed to file said application;
said sub contractor thereby emailing details of application.

42. An internet based service system comprising a host server computer apparatus, communication means and, a suitable user interface whereby said service system allows a user to instruct the filing of trade mark applications;
whereby said user interface provides a user with the facility to enter data relating to a trade mark comprising a constituent of said trade mark applications.

43. An internet-based service system comprising a host server computer apparatus, communication means and a suitable user interface whereby said service system allows a user to file a trade mark application;
whereby said user interface is configured with a plurality of menus said menus displaying country data whereby said user selects said country from said menu, said country being the country in which a trade mark application will be filed;
said user interface further providing said user with the facility to indicate whether said trade mark application will be filed under an international treaty;
said international treaty being a protocol relating to the Madrid agreement concerning the international registration of marks;
said international treaty further being community trademark regulation.

44. An internet-based service system comprising a host server computer apparatus, communication means and, a suitable user interface whereby said service system allows a user file a trade mark application;
whereby a user may select the filing of said trade mark application under the Madrid protocol;
said user interface comprising a plurality of menus;
whereby said user selects at least one country in which a Madrid Protocol trade mark application may be filed.

45. An internet-based service system comprising a host server computer apparatus, communication means, and a suitable user interface whereby said service system allows a user to file a trade mark application;
whereby said user interface allows said user to either:
file said trade mark application only or,
file said trade mark application together with payment of registration fees and/or;
instruct a search of suitable trade mark databases.

46. An internet-based service system comprising a host server computer apparatus, communication means and, a suitable user interface whereby said service system allows a user to instruct the filing of a trade mark application whereby said user interface allows said user to specify the goods/services where said goods/services form a constituent of said trade mark application;
whereby said user specifies said goods/services from a dropdown menu; or
whereby said user specifies goods/services using a check box;
said user interface further comprising the facility by which said user may enter data, said data further describing the classification of goods/services.

47. An internet-based service system comprising a host server computer apparatus, communication means and a suitable user interface whereby said service system allows a user to file a trade mark application;
whereby said user interface is configured to provide a user with the facility to enter data relating to a priority claim;
said data of priority claim comprising:
trade mark;
filing date;
application number;
specification of goods/services;
said data of said priority claim being entered by said user via a plurality of suitable menus and/or a facility whereby said user may input data.

48. An internet-based service system comprising a host server computer apparatus, communications means and a suitable user interface whereby said service system allows a user to file a trade mark application;
whereby said user interface provides a user with the facility to specify details of an applicant; said details of said applicant comprising:
name;
postal address;
country;
postcode;
email address;
telephone number;
fax number;
said details of said applicant being entered by said user using a plurality of suitable menus and/or;
via a suitable data entry means;
said user interface being further configured to allow said user to indicate whether said applicant is resident in an EC or non-EC country.

49. An internet-based service system comprising a cost server computer apparatus, communication means and a suitable user interface whereby said service system allows a user to file a trade mark application;
whereby said user interface provides said user with the facility to enter payment details;
said payment details comprising:
credit card number,
card type;
expiry date;
issue number;
name of cardholder;
said payment details for said trade mark application by said user being entered via said user interface using a plurality of a suitable menu and/or data entry means;
said user interface being further configured to indicate whether said payment of said trade mark application is by way of credit card transaction or check.

50. An internet-based service system comprising a host server computer apparatus, communication means, and a suitable user interface whereby said service system allows a user to file a trade mark application;
whereby said service system processes transaction data relating to said filing of said trade mark application;
said service system thereby outputting, via said user interface, substantially all of said application details;
said user thereby being given the option of reviewing said application details so as to either confirm said details of said application or edit said details of said application;
said application details selected from the set:
trade mark;
country or treaty;
Madrid countries;
priority marks;
filing date of priority mark;
application number of priority mark;
specification of goods/services of priority mark;
specification of goods/services;
filing;
filing and registration;
search;
applicant name;
applicant address;
applicant postcode;
applicant email address;
applicant telephone number;
applicant fax number;
applicant card number;
applicant card type;
applicant card expiry date;
applicant card issue number;
name of cardholder;
payment details;
total cost of said application.

51. An internet-based service system comprising a host server computer apparatus, communication means and a suitable user interface whereby said service system allows a user to file a trade mark application;
whereby upon confirmation of said application details said service system, via said user interface, informs said user as to the completion of data entry by said user.
